(19) United States
(12) Patent Application Publication
(10) Pub. No.: US 2009/0184897 A1
(43) Pub. Date: Jul. 23, 2009

(54) ELECTROPHORETIC DISPLAY PANEL DRIVING METHOD AND ELECTROPHORETIC DISPLAY PANEL

(75) Inventor: Tsutomu MIYAMOTO, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/271,973

(22) Filed: Nov. 17, 2008

(30) Foreign Application Priority Data
Jan. 18, 2008 (JP) 2008-008807

(51) Int. Cl. G09G 3/30

(52) U.S. Cl. 345/76

(57) ABSTRACT

An electrophoretic display panel includes an element substrate, a counter substrate, and an electrophoretic display layer interposed between the element substrate and the counter substrate. The element substrate includes a first data line set including plural data lines, second data line sets each including plural data lines branched from each of the plural data lines of the first data line set, plural scanning lines, and plural pixel electrodes. The plural pixel electrodes are disposed at locations where the plural data lines of the second data line sets intersect with the plural scanning lines. The counter substrate includes plural common electrodes, and one or more common electrodes is disposed opposite the plural pixel electrodes corresponding to one of the second data line sets.

### BACKGROUND

1. Technical Field

The present invention relates an electrophoretic display panel driving method and an electrophoretic display panel.

2. Related Art

In recent years, as a display device used in an apparatus such as an electronic paper or an electronic poster which needs a flexible property, non-luminescent type display devices having a flexible structure were used. One of the non-luminescent type display devices is an electrophoretic display device using an electrophoresis phenomenon. Here, the electrophoresis phenomenon is a phenomenon that particles (electrophoretic particles) migrate by the Coulomb force upon applying an electric field to a dispersal system in which the particles are dispersed in a fluid (dispersion medium). The electrophoretic display device is driven by changing potential between electrodes opposed to each other with the electrophoretic particles interposed therebetween by drive of thin film transistors and causing an electric field between the electrodes.

In the electrophoretic display device having a flexible property, organic thin film transistors (organic TFTs) having a flexible property are used in many cases. That is, the electrophoretic display device is configured by an active matrix type circuit, for example, using the organic TFTs as pixel transistors.

A method of configuring the electrophoretic display device by the active matrix type circuit was suggested (JP-A-2002-116733). JP-A-2002-116733 discloses the electrophoretic display panel which has a dispersion system in which electrophoretic particles are dispersed between an element substrate and a counter substrate and in which pixel electrodes, scanning lines, data lines, and pixel TFTs are formed in the element substrate and common electrodes are formed in the counter substrate. In addition, reduction in manufacture cost is realized by forming TFTs included in a scanning line driving circuit and a data line driving circuit in a process common to a process of forming the pixel TFTs in the element substrate.

However, the active matrix type circuit disclosed in JP-A-2002-116733 has the same configuration as that of known liquid crystal display devices. Moreover, a circuit driving the electrophoretic particles of which a response speed is lower than that of liquid crystal is unnecessarily costly.

In order to solve this problem, there was suggested a method of forming substrates for the electrophoretic display device at low cost. By this method, the active matrix type circuit which uses the organic TFTs as the pixel transistors is formed using an ink jet printer (ink jet process). A circuit formed in a substrate by the ink jet process can be manufactured at lower cost, compared to a circuit formed in a substrate by a known film forming technique or photolithography, and the active matrix type circuit can be manufactured at low cost.

However, an operation speed of the organic TFTs is lower than that of a known semiconductor element using silicon or the like. Therefore, known semiconductor elements need to be used in a circuit which operates at a relatively high speed and drives pixels with the active matrix type circuit, for example, in a semiconductor driver module including a scanning line driving circuit, a data line driving circuit, and the like. That is, even in the active matrix type circuit which includes the organic TFTs and is formed at low cost by the ink jet process, a problem also occurs when the electrophoretic display panel or the electrophoretic display device needs to be manufactured at low cost in that a known semiconductor driver module has to be used.

### SUMMARY

An advantage of some aspects of the invention is that it provides an electrophoretic display panel and a method of driving the electrophoretic display panel capable of driving pixels using a semiconductor element which outputs signals of which the number is smaller than the number of scanning lines or the number of data lines in semiconductor elements driving the scanning lines or the data lines formed on an active matrix substrate.

According to an aspect of the invention, there is provided an electrophoretic display panel includes an element substrate, a counter substrate, and an electrophoretic display layer interposed between the element substrate and the counter substrate. The element substrate includes a first data line set including plural data lines, second data line sets each including plural data lines branched from each of the plural data lines of the first data line set, plural scanning lines, and plural pixel electrodes. In addition, the plural pixel electrodes are disposed at locations where the plural second data lines sets intersect with the plural scanning lines. In addition, the counter substrate includes plural common electrodes, and each of the plural common electrodes is disposed opposite the plural pixel electrodes corresponding to one of the plural second data line sets.

With such a configuration, an electric field based on the data signal from the second data line sets is generated only between the common electrode in the active state owing to the application of a predetermined voltage and the plural pixel electrodes opposite the common electrode, in that each of the plural common electrodes provided on the counter substrate corresponds to the opposite plural pixel electrodes. That is, the display operation can be performed by the electrophoretic particles only between the common electrode in the active state among the plural common electrodes and the pixel electrodes opposite the common electrode. In this case, it is necessary to control synchronization of the supply of the data signal with the activated common electrode, since the data signal driving the pixel electrodes is supplied just by the number of the data line of the first data line set. However, the manufacture cost of the electrophoretic display panel is reduced since the size of the electric circuit driving the data signal becomes smaller. In this way, it is possible to perform the display operation on the electrophoretic display panel having a wider range by switching the plural common electrode activated in synchronization with the update timing of the data signal, and smoothly perform the display operation on the wider range panel by switching the data signal by an electric circuit which is more alert in an operation than the electrophoretic particles.

In the electrophoretic display panel having the above-described configuration, one of the plural common electrodes may be disposed opposite the plural pixel electrodes corresponding to one of the plural second data line sets.

With such a configuration, the plural common electrodes provided on the counter substrate and the plural pixel electrodes driven by the second data line sets correspond to each other one to one. Accordingly, the display operation can be performed when only one common electrode corresponding to the second data line set is activated in synchronization with the update timing of the data signal output to the second data line set. Moreover, the electrophoretic display panel can be easily put into practice, since the output of the data signal is easily controlled.

In the electrophoretic display panel having the above-described configuration, the plural common electrodes may be disposed opposite the plural pixel electrodes corresponding to one of the second data line set so as to be parallel to an arrangement direction of the data lines of the second data line set.

With such a configuration, the electrophoretic display penal is more easily manufactured and the manufacture cost is further reduced, since data signals necessary for display can be reduced, that is, the size of the electric circuit driving the data signals can be reduced thanks to more minute division of the common electrodes. In this case, it is possible to perform the display operation on the electrophoretic display panel having a wider range by switching the plural common electrodes activated in synchronization with the update timing of the data signal, and smoothly perform the display operation on the wider range panel by switching the data signal by the electric circuit which is more alert in an operation than the electrophoretic particles.

In the electrophoretic display panel having the above-described configuration, the plural scanning lines may include a first scanning line set including plural signal lines and second scanning line sets each including plural signal lines branched from each of the plural signal lines of the first scanning line set. In addition, the second scanning line sets may intersect with the second data line sets. In addition, each of the plural common electrodes may be disposed opposite the plural pixel electrodes corresponding to a location where one of the plural second data line sets interests with one of the plural second scanning line sets.

With such a configuration, the size of the electric circuit driving the scanning lines can be reduced so as to drive the number of the signal lines constituting the second scanning lines sets, by also dividing the common electrodes for the scanning lines minutely. With the miniaturization of the electric circuit driving the scanning lines, it is possible to easily manufacture the electrophoretic display panel and further reduce the manufacture cost. In this case, it is also possible to perform the display operation on the electrophoretic display panel having a wider range by switching the plural common electrodes activated in synchronization with the update timing of the data signal, and smoothly perform the display operation on the wider range panel by switching the data signal by the electric circuit which is more alert in an operation than the electrophoretic particles.

In the electrophoretic display panel having the above-described configuration, each of the plural pixel electrodes may be supplied with voltage through an organic transistor.

With such a configuration, the pixel electrodes are configured as the organic transistors. Therefore, the element substrate including the pixel electrodes can be formed with an ink jet printer (ink jet process). With the ink jet process, a circuit formed in a substrate by the ink jet process can be manufactured at lower cost, compared to a circuit formed in a substrate by a known film forming technique or photolithography. Accordingly, it is possible to provide a liquid crystal display panel manufactured at lower cost.

The electrophoretic display panel is applicable to an electronic paper, an electronic poster, an electronic book, or the like, since the organic transistor has a flexible property.

According to another aspect of the invention, there is provided a method of driving an electrophoretic display panel which includes an element substrate, a counter substrate, and an electrophoretic display layer interposed between the element substrate and the counter substrate. The element substrate includes a first data line set including plural data lines, second data line sets each including plural data lines branched from each of the plural data lines of the first data line set, plural scanning lines, and plural pixel electrodes. In addition, the plural pixel electrodes may be disposed at locations where the plural second data lines sets intersect with the plural scanning lines. In addition, the counter substrate may include plural common electrodes and each of the plural common electrodes is disposed opposite the plural pixel electrodes corresponding to one of the plural second data line sets. In addition, a data signal output to the first data line set may be updated by the number of the second data line sets while one of the plural scanning lines is driven to be in an active state. In addition, voltage necessary for display change may be supplied at update timing of the data signal to one of the plural common electrodes disposed opposite the location corresponding to one of the second data line sets corresponding to the updated data signal.

With such a method, in the electrophoretic display panel performing the display operation only between the common electrode activated by the supply of a predetermined voltage and the pixel electrodes opposite the common electrode, the data signal for each of the second data line sets which is output to the first data line set is updated and the display operation is performed in the range of the common electrode in synchronization with the supply of the voltage to the common electrode. Even with the electrophoretic display panel having a small electric circuit driving the data signal, it is possible to perform the display operation on the wider range panel by sequentially switching the common electrodes in synchronization with the update timing of the data signal.

In the method of driving the electrophoretic display panel having the above-described configuration, one of the plural common electrodes may be disposed opposite the plural pixel electrodes corresponding to one of the plural second data line sets.

With such a method, the plural common electrodes provided on the counter substrate and the plural pixel electrodes driven by the second data line sets correspond to each other one to one. Accordingly, the display operation can be performed when only one common electrode corresponding to the second data line set is activated in synchronization with the update timing of the data signal output to the second data line set. Moreover, the electrophoretic display panel can be easily put into practice, since the output of the data signal is easily controlled.

In the method of driving the electrophoretic display panel having the above-described configuration, the plural common electrodes may be disposed opposite the plural pixel electrodes corresponding to one of the second data line set so as to be parallel to an arrangement direction of the data lines of the second data line set. In addition, each of the data lines corresponding to the disposed plural common electrodes may be updated in update of the number of the second data line sets, and the voltage necessary for display change is supplied to one of the plural common electrodes at the update timing.

With such a method, it is possible to appropriately perform the display operation even on the electrophoretic display panel in which the common electrodes are more minutely divided.

In the method of driving the electrophoretic display panel having the above-described configuration, the plural scanning lines may include a first scanning line set including plural signal lines and second scanning line sets each including plural signal lines branched from each of the plural signal lines of the first scanning line set. In addition, the second scanning line sets may intersect with the second data line sets. In addition, each of the plural common electrodes may be disposed opposite the plural pixel electrodes corresponding to a location where one of the plural second data line sets interests with one of the plural second scanning line sets. In addition, the voltage necessary for the display change may be supplied to one of the plural pixel electrodes by driving one of the plural signal lines at a display location of a data signal output the second data line sets.

With such a method, it is possible to appropriately drive even the electrophoretic display panel in which the size of the electric circuit driving the scanning lines can be reduced up to the size so as to drive the number of the signal lines constituting the second scanning line sets.

In the method of driving the electrophoretic display panel having the above-described configuration, the voltage necessary for the display change may be simultaneously supplied to two of the plural common electrodes adjacent to each other in a direction parallel to the arrangement direction of the second scanning line sets during a certain period.

With such a method, the voltage necessary for the common electrode opposite the pixel electrodes driven on the basis of the data signal is supplied to perform the display operation by the driven pixel electrodes, even when the arrangement of the plural pixel electrodes scanned by the second scanning line set and the common electrode opposite the plural pixel electrodes is deviated in a direction parallel to the arrangement direction of the scanning line set.

### BRIEF DESCRIPTION OF THE DRAWINGS

The invention will be described with reference to the accompanying drawings, wherein like numbers reference like elements.

FIG. 1 is a plan view illustrating an entire display panel including electrophoretic particles according to an embodiment of the invention.

FIG. 2 is a sectional view illustrating a cross section configuration of the display panel according to the embodiment.

FIG. 3 is a sectional view illustrating the cross section configuration of the display panel according to the embodiment.

FIG. 4 is a circuit diagram illustrating the circuit configuration of an element substrate according to the embodiment.

FIG. 5 is a circuit diagram illustrating an equivalent circuit of a pixel portion according to the embodiment.

FIG. 6 is a circuit diagram illustrating the circuit configuration of a counter substrate according to the embodiment.

FIG. 7 is a diagram illustrating an electric configuration in which the element substrate and the counter substrate are opposed to each other according to the embodiment.

FIG. 8 is a time chart for explaining a display operation according to the embodiment.

FIG. 9 is a diagram illustrating another electric configuration in which the element substrate and the counter substrate are opposed to each other in a different example.

FIG. 10 is a time chart for explaining a display operation in the different example.

FIG. 11 is a time chart for explaining a display operation in a still different example.

### DESCRIPTION OF EXEMPLARY EMBODIMENTS

Hereinafter, an electrophoretic display panel and a method of driving the electrophoretic display panel will be described with reference to the drawings according to a first embodiment of the invention.

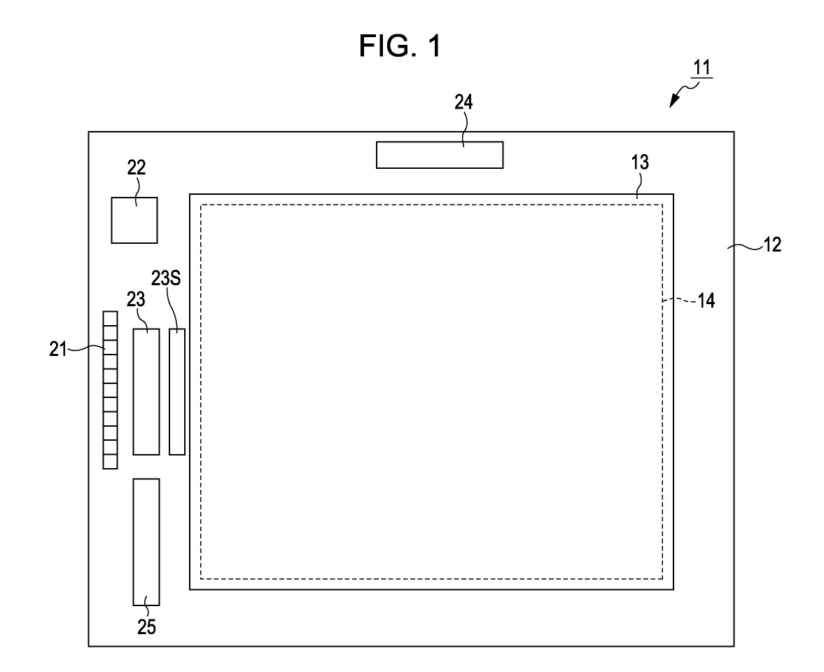

FIG. 1 is a plan view illustrating the configuration of an electrophoretic display panel (display panel) 11.

As shown in FIG. 1, the display panel 11 includes an element substrate 12, a counter substrate 13, and an electrophoretic display layer 14 interposed between the element substrate 12 and the counter substrate 13.

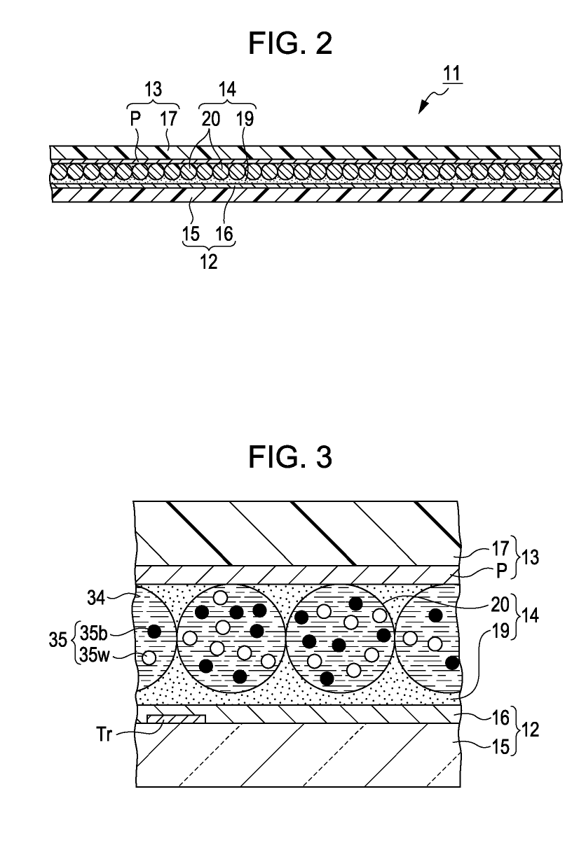

As shown in FIG. 2, the element substrate 12 includes a rear surface substrate 15 having a flexible property. An element formation layer 16 is formed on one surface (an upper surface in FIG. 2) of the rear surface substrate 15. The rear surface substrate 15 is formed of a thermoplastic resin material or a thermohardening resin having an excellent flexibility and an excellent elasticity, such as polyethylene terephthalate, polycarbonate, polyimide, and polyethylene. In the element formation layer 16, plural conductive layers and plural insulation layers are formed. For example, organic transistors Tr (see FIG. 3), pixel electrodes, various wirings are formed. In this embodiment, a p-channel type organic transistor Tr is described in this embodiment, but an n-channel type organic transistor or other type organic transistors may be used.

As shown in FIG. 3, the organic transistors Tr are formed as field effect transistors which are formed by laminating an insulation layer forming the element formation layer 16, electrodes, and an organic semiconductor layer in a predetermined order on the upper surface of the rear substrate 15. The electrodes are formed of a conductive material, for example, a metal material such as gold, copper, and aluminum, indium tin oxide, or an electrically conductive polymer such as polyaniline. On the other hand, the insulation layer is formed of a material having an insulation property, such as polymethylmethacrylate, polyvinylphenol, polyimide, polystyrene, polyvinyl alcohol, and polyvinyl acetate, or a material combined with two or more thereof. In addition, the organic semiconductor layer is formed of pentacene, arylamine, P3HT, PQT, F8T2, DPh-BTBT, or the like.

The counter substrate 13 includes a transparent substrate 17 having a flexible property. Plural separate counter electrodes P as common electrodes are formed in a matrix shape on one surface (a lower surface in FIG. 2) of the counter substrate 13. In addition, the separate counter electrodes P correspond to predetermined plural pixels. The transparent substrate 17 is formed of a thermoplastic resin material or a thermohardening resin having an excellent flexibility and an excellent elasticity, such as polyethylene terephthalate, polycarbonate, polyimide, and polyethylene. The separate counter electrodes P are formed of a conductive material having a transparent property, for example, indium tin oxide or an electrically conductive polymer such as or polyaniline.

The electrophoretic display layer 14 includes several microcapsules 20 integrated by a binder 19. As shown in FIG. 3, each of the microcapsules 20 seals an electrophoretic dispersion medium 34 as a dispersal system and electrophoretic particles 35. The electrophoretic particles 35 are constituted by white particles 35w charged with a positive or a negative polarity and black particles 35b charged with a polarity different from the white particles 35w. In addition, the electrophoretic particles 35 migrate in the electrophoretic dispersion medium 34 in a direction of an electric field applied to each of the microcapsules 20.

The microcapsule 20 is formed of a compound of arabic gum and gelatine or a urethane-based compound, for example. The electrophoretic dispersion medium 34 is formed of water, methanol, or ethanol, for example. The electrophoretic particles 35 are formed of aniline black, carbon black, or titanium dioxide, for example.

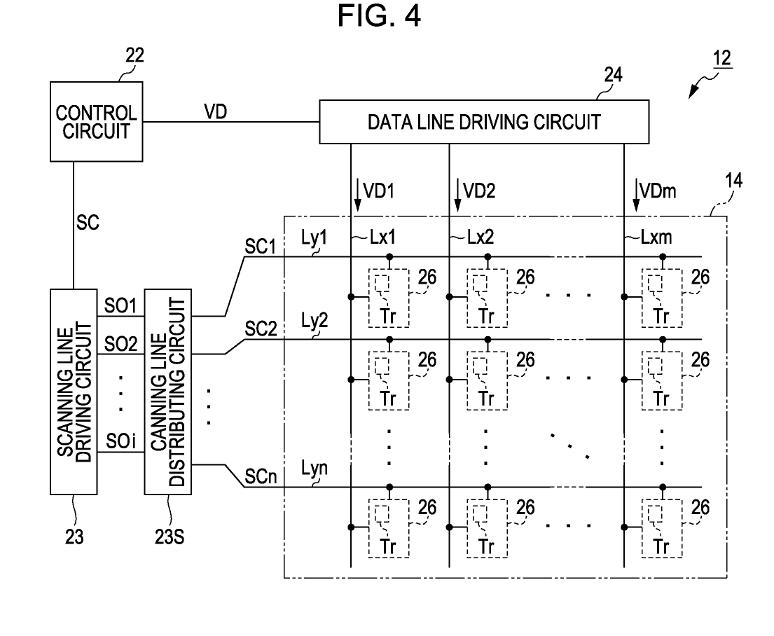

In the element substrate 12, as shown in FIG. 4, n scanning lines Ly1, Ly2, . . . , Lyn (where n is a natural number) which are signal lines formed across a substantially entire width in a horizontal direction are arranged, and m data lines Lx1, Lx2, . . . , Lxm (where m is a natural number) which are signal lines formed across a substantially entire width in a vertical direction are arranged.

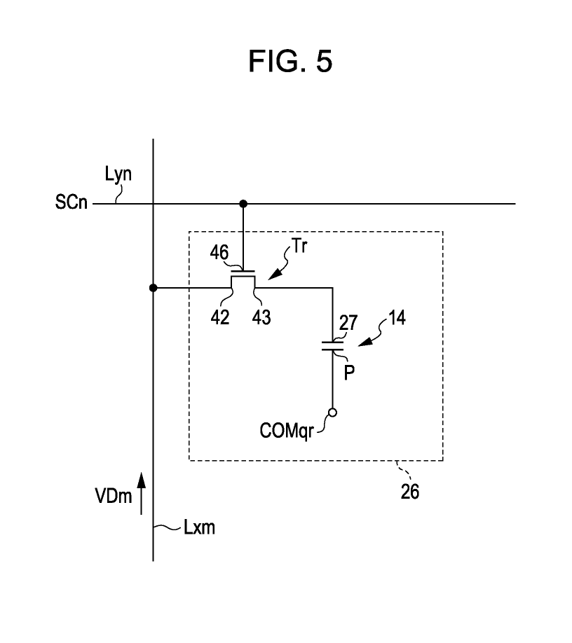

A pixels 26 connected to each of the scanning lines Ly1 to Lyn and each of the data lines Lx1 to Lxm is disposed at each of locations where the scanning lines Ly1 to Lyn intersect with the data lines Lx1 to Lxm. That is, the plural pixels 26 are disposed in a matrix shape on the element substrate 12. Moreover, the pixel 26 includes a control element such as the organic transistor Tr and a pixel electrode 27 (see FIG. 5) having a light-transmitting property and formed of a transparent conductive film.

FIG. 5 shows an equivalent circuit of the pixel 26 disposed in correspondence to the location where an m-th data line Lxm interests with an n-th scanning line Lyn. The pixel 26 includes one organic transistor Tr, the electrophoretic display layer 14 having an area corresponding to the pixel electrode 27, and the separate counter electrode P corresponding to the pixel electrode 27.

A gate electrode 46 of the organic transistor Tr is connected to the n-th scanning line Lyn and a source electrode 42 of the organic transistor Tr is connected to the m-th data line Lxm. A drain electrode 43 of the organic transistor Tr is connected to the pixel electrode 27.

The separate counter electrode P is disposed at a location opposite the pixel electrode 27 through the electrophoretic display layer 14.

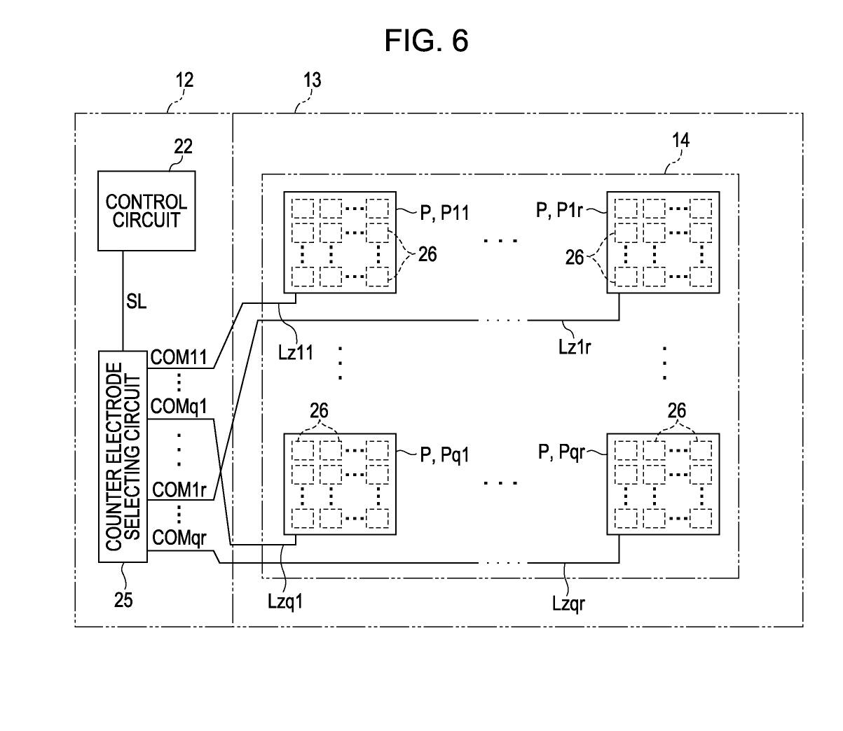

As shown in FIG. 6, the plural separate counter electrodes P are arranged at locations corresponding to the electrophoretic display layer 14 of the counter substrate 13. Each of the separate counter electrodes P is larger than the pixels 26 so as to correspond to the plural pixels 26. That is, the plural pixel electrodes 27 share one separate counter electrode P formed in the counter substrate 13 at a location opposite each other. In this embodiment, q separate counter electrodes in a vertical direction (where q is a natural number) and r separate counter electrodes in a horizontal direction (where r is a natural number), that is, the total q×r separate counter electrodes P (P11 to Pqr) are formed in a matrix shape.

Electrode selection lines Lz11 to Lzqr are electrically connected to the separate counter electrodes P (P11 to Pqr). Moreover, the electrode selection lines Lz11 to Lzq1 are sequentially connected to the separate counter electrodes P11 to Pq1 arranged in the most left column. The electrode selection lines Lz1r to Lzqr are sequentially connected to the separate counter electrodes P1r to Pqr arranged in the most right column.

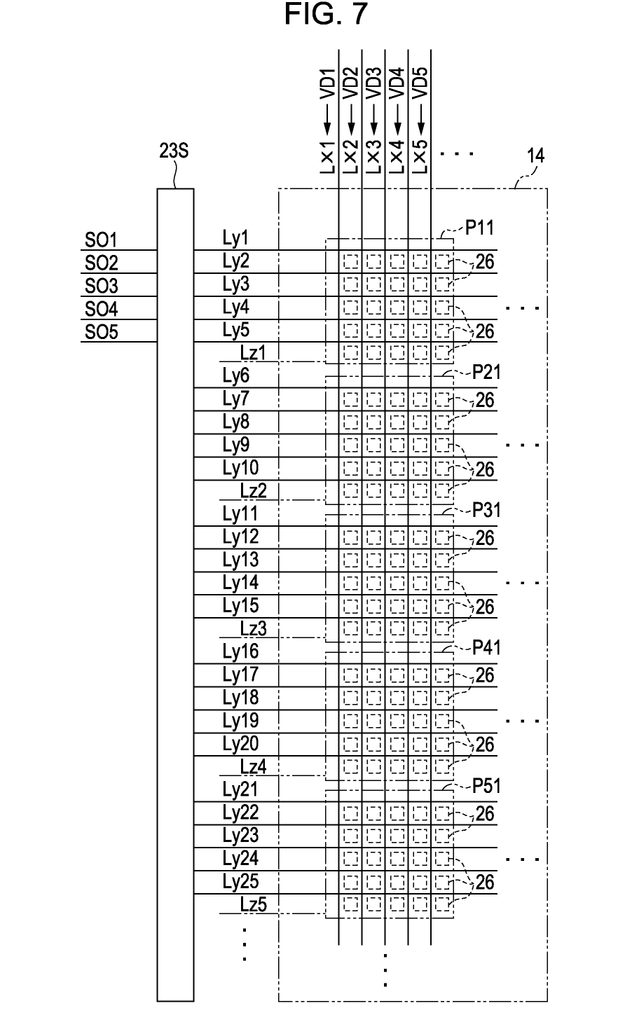

In this embodiment, as shown in FIG. 7, it is assumed that five separate counter electrodes in the vertical direction and five separate counter electrodes in the horizontal direction, that is, twenty five (=5×5) pixel electrodes 27 (the pixels 26) corresponding to one separate counter electrode P are arranged.

As shown in FIG. 1, a control circuit 22, on a left side of the upper surface of the element substrate 12, there are provided a scanning line driving circuit 23, a scanning line distributing circuit 23S, and a counter electrode selecting circuit 25 which generate predetermined signals used to display an image on the display panel 11 on the basis of external signals or the like transmitted and received through the external connection terminal 21. In addition, on the upper side of the upper surface of the element substrate 12, there is provided a data line driving circuit 24 which generates a predetermined signal on the basis of an external signal or the like.

Next, the electric configuration of the display panel 11 will be described with reference to FIGS. 4 to 6.

As shown in FIGS. 4 to 6, the control circuit 22 is electrically connected to the scanning line driving circuit 23, the data line driving circuit 24, and the counter electrode selecting circuit 25.

The scanning line driving circuit 23 is electrically connected to the scanning line distributing circuit 23S through a first scanning line set of plural signal lines to output i distribution scanning signals SO1 to SOi (where i is a natural number and smaller than n) to the scanning line distributing circuit 23S.

In this embodiment, as shown in FIG. 7, the distribution scanning signals SO1 to SO5 will be described on the assumption that i is five for convenient explanation. In addition to the five distribution scanning signals SO1 to SO5, the n scanning lines Ly1 to Lyn will be described on the assumption that twenty five scanning lines Ly1 to Ly25 are arranged.

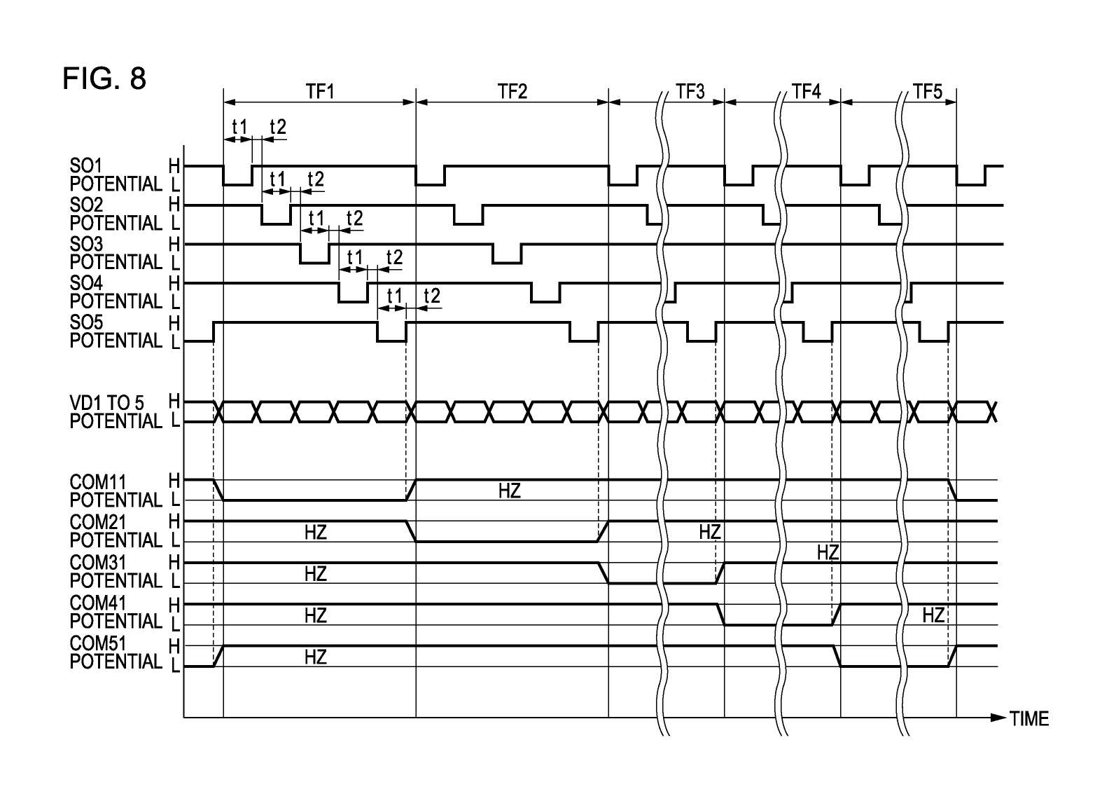

As shown in FIG. 8, the five distribution scanning signals SO1 to SO5 become an L level as first voltage at writing time t1 in an order from the distribution scanning signal SO1 in response to timing signal SC sent from the control circuit 22. After the final distribution signal SO5 becomes the L level at the writing time t1, the same operation is repeatedly performed again from the distribution scanning signal SO1. Accordingly, when one of the distribution scanning signals SO1 to SO5 becomes the L level, the other four distribution scanning signals have to become an H level. When the distribution scanning signals SO1 to SO5 rise from the L level to the H level, the next distribution scanning signals SO1 to SO5 drop to the L level after switching time t2. In this embodiment, the L level is “0 V” and the H level is driving voltage of the organic transistor Tr.

Here, a period for which the distribution scanning signal SO1 drops and the next scanning signal SO1 again drops is referred to as one sub-field.

The five distribution scanning signals SO1 to SO5 each correspond to one of the five scanning lines of the respective second scanning line sets which are each constituted by five continuous scanning lines in the twenty five scanning lines Ly1 to Ly25 in the vertical direction. The five distribution scanning signals SO1 to SO5 are each output at the same time to one scanning line of each of the second scanning line sets by the scanning line distributing circuit 23S.

Specifically, in FIG. 8, the scanning line distributing circuit 23S outputs the distribution scanning line SO1 to the scanning line Ly1 of the second scanning line set constituted by the scanning lines Ly1 to Ly5 (first set), the scanning line Ly6 of the second scanning line set constituted by the scanning lines Ly6 to Ly10 (second set), the scanning line Ly11 of the second scanning line set constituted by the scanning lines Ly11 to Ly15 (third set). In addition, the scanning line distributing circuit 23S outputs the distribution scanning line SO1 to the scanning line Ly16 of the second scanning line set constituted by the scanning lines Ly16 to Ly20 (fourth set) and the scanning line Ly21 of the second scanning line set constituted by the scanning lines Ly21 to Ly25 (fifth set).

The scanning line distributing circuit 23S outputs the distribution scanning line SO2 to the scanning line Ly2 of the first set, the scanning line Ly7 of the second set, the scanning line Ly12 of the third set, the scanning line Ly17 of the fourth set, and the scanning line Ly22 of the fifth set.

The scanning line distributing circuit 23S outputs the distribution scanning line SO3 to the scanning line Ly3 of the first set, the scanning line Ly8 of the second set, the scanning line Ly13 of the third set, the scanning line Ly18 of the fourth set, and the scanning line Ly23 of the fifth set.

The scanning line distributing circuit 23S outputs the distribution scanning line S04 to the scanning line Ly4 of the first set, the scanning line Ly9 of the second set, the scanning line Ly14 of the third set, the scanning line Ly19 of the fourth set, and the scanning line Ly24 of the fifth set.

The scanning line distributing circuit 23S outputs the distribution scanning line SO5 to the scanning line Ly5 of the first set, the scanning line Ly10 of the second set, the scanning line Ly15 of the third set, the scanning line Ly20 of the fourth set, and the scanning line Ly25 of the fifth set.

That is, five scanning lines are simultaneously selected among the twenty five scanning lines Ly1 to Ly 25 at an interval of four scanning lines.

The pixels 26 selected in the scanning lines Ly1 to Ly5 of the first set correspond to the separate counter electrodes P11 to P1r arranged in the uppermost row on the counter substrate 13. In addition, the pixels 26 selected in the scanning lines Ly6 to Ly10 of the second set correspond to the separate counter electrodes P21 to P2r arranged on the counter substrate 13.

The pixels 26 selected in the scanning lines Ly11 to Ly15 of the third set correspond to the separate counter electrodes P31 to P3r arranged on the counter substrate 13. The pixels 26 selected in the scanning lines Ly16 to Ly20 of the fourth set correspond to the separate counter electrodes P41 to P4r arranged on the counter substrate 13. The pixels 26 selected in the scanning lines Ly21 to Ly25 of the fifth set correspond to the separate counter electrodes P51 to P5r arranged on the counter substrate 13.

The data line driving circuit 24 is electrically connected to the m data line Lx1 to Lxm. The data line driving circuit 24 outputs data signals VD1 to VDm to the m data lines Lx1 to Lxm, respectively. In this embodiment, the data signals VD1 to VDm are signals which have an L level or an H level.

In this embodiment, as shown in FIG. 7, the data signals VD1 to VDm will be described on the assumption that m is five for convenient explanation. In addition to the five data signals VD1 to VD5, the m data lines Lx1 to Lxm will be described on the assumption that five data lines Lx1 to Lx5 are used.

As shown in FIG. 8, the data line driving circuit 24 switches the five data signals VD1 to VD5 newly and outputs simultaneously five new data signals VD1 to VD5 in response to the drop in the distribution scanning signals SO1 to SO5, that is, in response to a timing signal VD set from the control circuit 22.

As shown in FIG. 6, the counter electrode selecting circuit 25 connected to the control circuit 22 is electrically connected to the electrode selection lines Lz11 to Lzqr, and thus outputs electrode selection signals COM11 to COMqr to the electrode selection lines Lz11 to Lzqr corresponding to the electrode selection signals COM11 to COMqr in response to a timing signal SL sent from the control circuit 22.

In this embodiment, as shown in FIG. 7, the separate counter electrodes P will be described on the assumption that five separate counter electrodes arranged in the vertical direction and one separate counter electrode arranged in the horizontal direction, that is, five (5×1) separate counter electrodes P11 to P51 in total are arranged for convenient explanation. Accordingly, five electrode selection signal COM11 to COM51 are arranged.

As shown in FIG. 8, the electrode selection signals COM11 to COM51 become the L level from the electrode selection signal COM11 in response to the timing signal SL sent from the control circuit 22 during one sub-field period T1. When the final electrode selection signal COM51 is in the L level during one sub-field period T1, the same operation is repeatedly performed from the next electrode selection signal COM11. That is, after one sub-field period continues five times, the same operation is performed from the electrode selection signal COM11. Accordingly, when one of the electrode selection signals COM11 to COM51 becomes the L level, the other four electrode selection signals have to be in high impedance (Hz).

Specifically, the electrode selection signal COM11 becomes the L level during a first sub-field TF1, the electrode selection signal COM21 becomes the L level during a second sub-field TF2, the electrode selection signal COM31 becomes the L level during a third sub-field TF3, the electrode selection signal COM41 becomes the L level during a fourth sub-field TF4, and the electrode selection signal COM51 becomes the L level during a fifth sub-field TF5.

The pixels 26 in which the electrode selection signals COM11 to COM51 become the L level and the voltage of the L level is applied to the separate counter electrodes P11 to P51 become a state where a display operation is enabled in accordance with the data signals VD1 to VD5 input to the pixel electrodes 27 upon inputting the data signals VD1 to VD5.

Conversely, the pixels 26 in which the electrode selection signals COM11 to COM51 are in the high impedance (Hz) and the separate counter electrodes P11 to P51 are in the high impedance (Hz) become a state where the display operation is not enabled in accordance with the data signals VD1 to VD5 input to the pixel electrodes 27, when the data signal VD1 to VD5 are input.

In FIG. 8, when the scanning lines Ly1 to Ly5 for the separate counter electrode P11 are selected during the first sub-field TF1, the pixels 26 sharing the separate counter electrode P11 perform the display operation in the selected order on the basis of the output data signals VD1 to VD5. When the scanning lines Ly6 to Ly10 for the separate counter electrode P21 are selected during the second sub-field TF2, the pixels 26 sharing the separate counter electrode P21 perform the display operation in the selected order on the basis of the output data signals VD1 to VD5.

When the scanning lines Ly11 to Ly15 for the separate counter electrode P31 are selected during the third sub-field TF3, the pixels 26 sharing the separate counter electrode P31 perform the display operation in the selected order on the basis of the output data signals VD1 to VD5. When the scanning lines Ly16 to Ly20 for the separate counter electrode P41 are selected during the fourth sub-field TF4, the pixels 26 sharing the separate counter electrode P41 perform the display operation in the selected order on the basis of the output data signals VD1 to VD5.

When the scanning lines Ly21 to Ly25 for the separate counter electrode P51 are selected during the fifth sub-field TF5, the pixels 26 sharing the separate counter electrode P51 perform the display operation in the selected order on the basis of the output data signals VD1 to VD5.

As described above, advantages described below are obtained in the electrophoretic display panel and the method of driving the electrophoretic display panel according to this embodiment.

(1) In the above-described embodiment, the electrode selection signals COM11 to COM51 in the L level during every one sub-field are switched to perform the display operation on the display panel 11 using the five distribution scanning signals SO1 to SO5 and the five data signals VD1 to VD5. Accordingly, an image is displayed when the scanning line driving circuit 23 outputs the five distribution scanning signals SO1 to SO5 in the element substrate 12 provided with the twenty five scanning lines Ly1 to Ly25. As a result, the display panel 11 is configured using the scanning line driving circuit 23 capable of outputting the number of signals smaller than the number of the scanning lines, that is, the scanning line driving circuit 23 manufactured with a small size and at low cost.

(2) In the above-described embodiment, the total 125 pixels 26 are displayed when the scanning line driving circuit 23 outputs the five distribution scanning signals SO1 to SO5, the data line driving circuit 24 outputs the five data signal VD1 to VD5, the counter electrode selecting circuit 25 outputs the five electrode selection signals COM11 to COM51, that is, the circuits output just a total of fifteen signals. However, in the known example, the scanning line driving circuit 23 outputs twenty five scanning line signals and the data line driving circuit 24 output five data signals VD1 to VD5, that is, the total thirty signals are necessary. Accordingly, it is possible to considerably reduce the number of output signals.

(3) In the above-described embodiment, the scanning line distributing circuit 23S is provided in the element substrate 12. Accordingly, connection wirings for connecting the five distribution scanning signals SO1 to SO5 to the scanning lines Ly1 to Ly25 are easily formed, when the element substrate is formed.

(4) In the above-described embodiment, the separate counter electrodes P11 to P51 formed on the counter substrate 13 of the electrophoretic display panel 11 are switched using the electrode selection signals COM11 to COM51 to perform the display operation or not to perform the display operation. Accordingly, the driving method can be used even in the element substrate 12 equipped with a known active matrix type circuit.

(5) In the above-described embodiment, there are provided the separate counter electrodes P11 to P51 switching between the L level and the high impedance (Hz) using the electrode selection signals COM11 to COM51 in the electrophoretic display panel 11. Accordingly, it is possible to manufacture the electrophoretic display panel 11 which does not need to switch a display image at a high speed at low cost.

### Other Embodiments

The above-described embodiment may be modified into forms described below.

In the above-described embodiment, the scanning line driving circuit 23 distributes the five distribution scanning signals SO1 to SO5 to the twenty five scanning lines Ly1 to Ly25. However, the invention is not limited thereto, but the data line driving circuit 24 may output data signals corresponding to the number of the distribution scanning signals which is the smaller than the number of data signal lines through the first data line set to distribute the data signals to the data signal lines constituting the second data line sets. For example, five continuous data lines among the twenty five data lines Lx1 to Lx25 in the horizontal direction are set to one second data line set, and the data line driving circuit 24 may output five distribution data signals corresponding to the number of the distribution scanning signals through the first data line set. Even in this case, the data lines Lx1, Lx6, Lx11, Lx16, and Lx21 at an interval of five data lines are connected. Likewise, data lines at the interval of five data lines are connected from the data line Lx2, data lines at the interval of five data lines are connected from the data line Lx3, data lines at the interval of five data lines are connected from the data line Lx4, and data lines at the interval of five data lines are connected from the data line Lx5. Accordingly, since it is possible to reduce the number of the data signals output from the data line driving circuit 24, the data line driving circuit 24 with a smaller size and at low cost can be used.

Like the distribution of the scanning lines Ly1 to Ly25, a data line distributing circuit distributing the data lines Lx1 to Lx25 may be provided in the element substrate 12. With such a configuration, it is relatively easy to secure an area necessary for the data line distributing circuit and the data lines are easily distributed with laminated wirings.

By switching the data signals by the data line driving circuit 24 which is more alert in motion than the electrophoretic particles 35, it is possible to smoothly perform the display operation of the electrophoretic display panel having a wide display range for switching the plural separate counter electrodes.

In the above-described embodiment, every five scanning lines among the scanning lines Ly1 to Ly25 are one set, and the sets correspond to the separate counter electrodes P11 to P51, respectively. However, the invention is not limited thereto. In the element substrate 12 and the counter substrate 13, a relative relation between the scanning lines Ly1 to Ly25 and the separate counter electrodes P may be slightly deviated more than a predetermined location relation in a direction of the scanning lines.

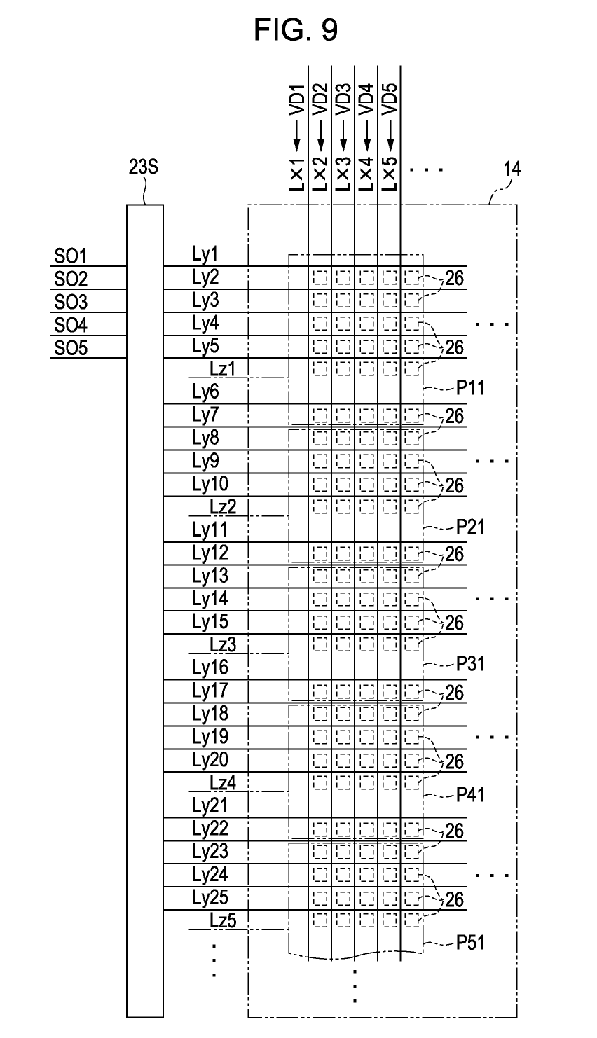

Specifically, as shown in FIG. 9, the scanning line Ly6 may be slightly deviated from the separate counter electrode P21 in the direction of the scanning lines in correspondence to the separate counter electrode P11.

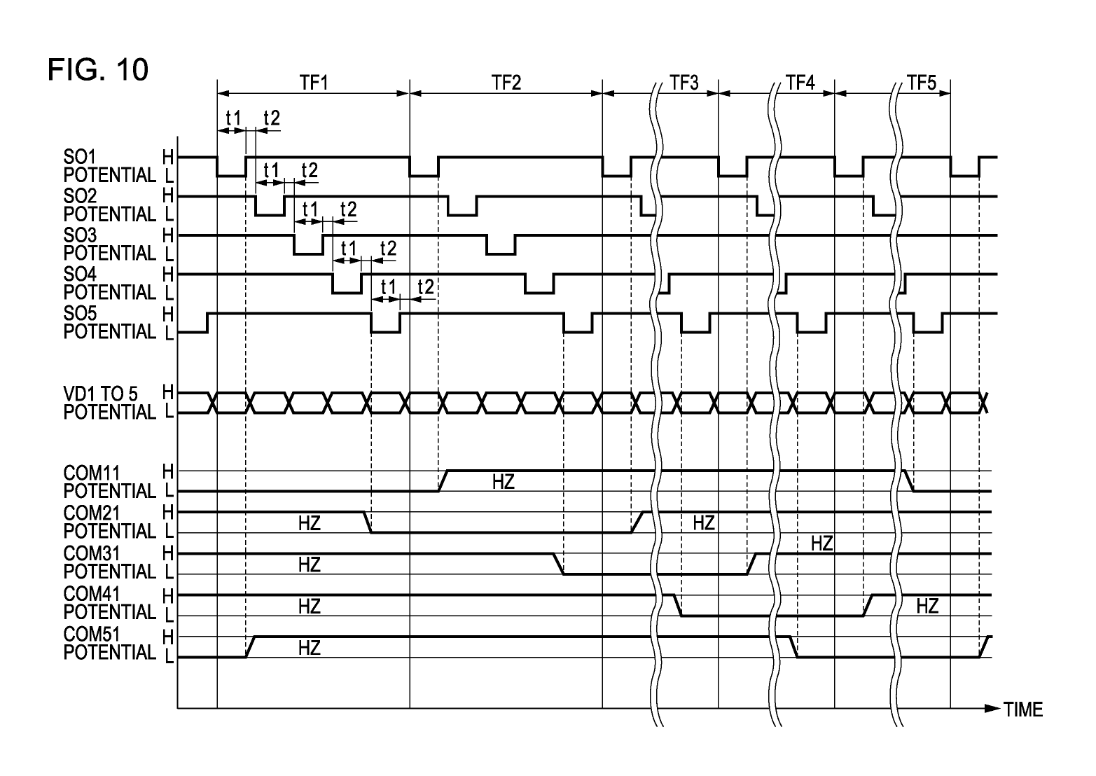

In this case, as shown in FIG. 10, the separate counter electrode P11 is set to the L level until the distribution scanning signal SO1 of a second sub-field TF2 ends. Then, when the scanning line Ly6 is scanned, the separate counter electrode P11 which corresponds by the deviation of the pixels 26 connected to the scanning line Ly6 maintains the L level. Therefore, the pixels 26 connected to the scanning line Ly6 can perform the display operation. Accordingly, it is possible to appropriately drive the electrophoretic display panel 11, even when it is difficult to attach the element substrate 12 and the counter substrate 13 to each other at a predetermined location due to the large sizes of the element substrate 12 and the counter substrate 13.

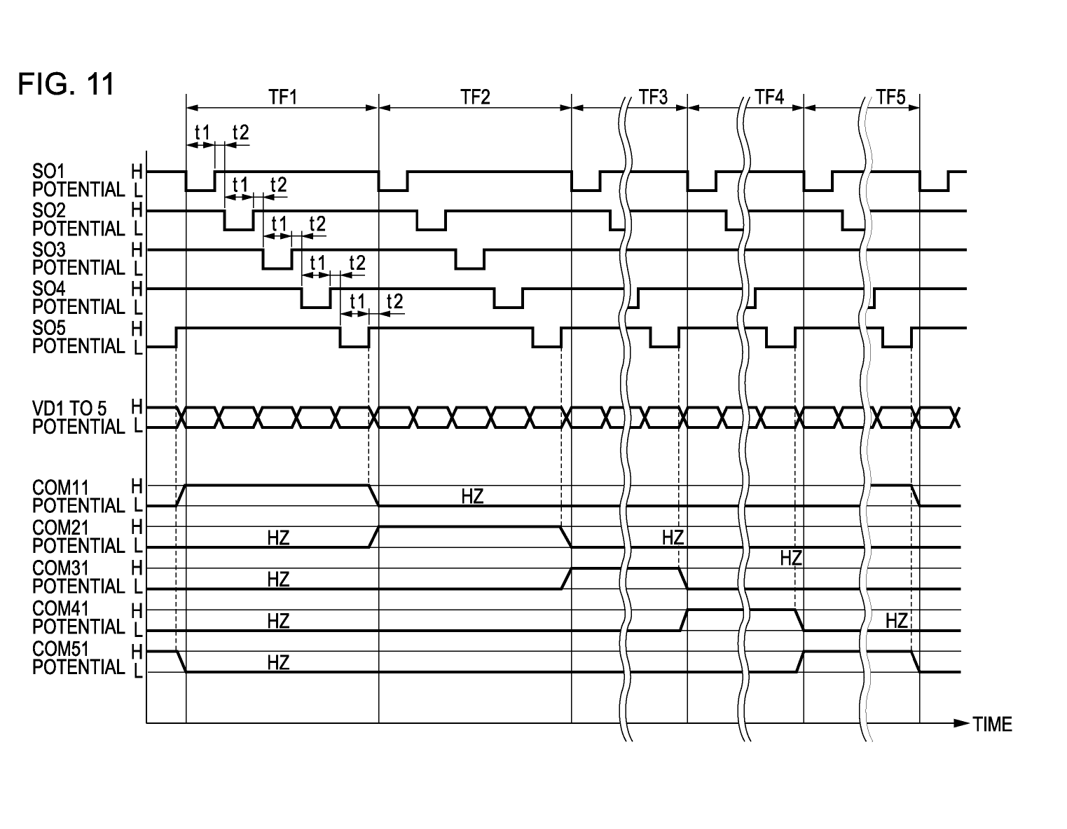

In the above-described embodiment, the p-channel type organic transistor Tr has been described. However, the invention is not limited thereto, but an n-channel type organic transistor or other channel type organic transistors may be used. For example, as for an n-channel type organic transistor Tr, as shown in FIG. 11, the pixels 26 can perform the display operation with an H level of the electrode selection signals COM11 to COM51 for the separate counter electrodes P11 to P51. Therefore, it is not necessary for the electrode selection signals COM11 to COM51 to perform the display operation with the high impedance (Hz).

In the above-described embodiment, the L level is set to “0 V” and the H level is set to the driving voltage of the organic transistor Tr. However, the invention is not limited thereto, but the L level and the H level may be set to voltage having a potential difference by which an on-state and an off state of the organic transistor can be switched in accordance with the characteristics of the organic transistor.

In the above-described embodiment, the five distribution scanning signals SO1 to SO5 are output from the scanning line driving circuit 23. In addition, the five data signals VD1 to VD5 are output from the data line driving circuit 24. However, the number of the distribution scanning signals output from the scanning line driving circuit 23 and the number of the data signals output from the data line driving circuit 24 are not particularly limited.

In the above-described embodiment, the pixels 26 can perform the display operation or cannot perform the display operation in the electrophoretic display panel 11. However, the invention is not limited thereto, but other type display apparatuses using an active matrix type circuit may be used.

In the above-described embodiment, the writing time t1 is time for which the data signals VD1 to VD5 are in a normal state and the switching time t2 is time for which the data signals VD1 to VD5 are in a transient state. However, the invention is not limited thereto, but the writing time t1 may be time shorter than time of the normal state and the switching time t2 may be time longer than the time of the transient state.

As for the writing time t1, the L level and the H level may be repeated during the time of the normal state. Accordingly, by setting the L level during the writing time t1 in the normal state, that is, changing the method of driving the organic transistor Tr, it is possible to display an image on the electrophoretic display panel 11 in a desired manner.

In the above-described embodiment, the scanning line driving circuit 23 outputs the distribution scanning lines in the order from the distribution scanning line SO1 to the distribution scanning line SO5. However, the invention is not limited thereto, but the distribution scanning lines may be output in an order from the distribution scanning line SO5 to the distribution scanning line SO1. That is, the distribution scanning lines may be scanned in a direction from the scanning line Ly5 to the scanning line Ly1.

In the above-described embodiment, the control circuit 22, the scanning line driving circuit 23, the data line driving circuit 24, and the counter electrode selecting circuit 25 are provided on the element substrate 12. However, the invention is not limited thereto, but at least one of the control circuit 22, the scanning line driving circuit 23, the data line driving circuit 24, and the counter electrode selecting circuit 25 may be provided outside the display panel 11, for example, a flexible printed circuit (FPC) connected to the external connection terminal 21.

In the above-described embodiment, the counter electrode selecting circuit 25 is provided on the element substrate 12, but may be provided on the counter substrate 13.

In the above-described embodiment, the scanning line distributing circuit 23S is provided on the element substrate 12. However, the scanning line distributing circuit 23S may be included in the scanning line driving circuit 23. Moreover, when the scanning line driving circuit 23 is provided outside the display panel 11, the scanning line distributing circuit 23S may also be provided outside the display panel 11.

The entire disclosure of Japanese Patent Application No. 2008-008807, filed Jan. 18, 2008 is expressly incorporated by reference herein.

What is claimed is:

1. An electrophoretic display panel which includes an element substrate, a counter substrate, and an electrophoretic display layer interposed between the element substrate and the counter substrate,
wherein the element substrate includes a first data line set including plural data lines, second data line sets each including plural data lines branched from each of the plural data lines of the first data line set, plural scanning lines, and plural pixel electrodes,
wherein the plural pixel electrodes are disposed at locations where the plural data lines of the second data line sets intersect with the plural scanning lines, and
wherein the counter substrate includes plural common electrodes, and one or more common electrodes is disposed opposite the plural pixel electrodes corresponding to one of the second data line sets.

2. The electrophoretic display panel according to claim 1, wherein one of the plural common electrodes is disposed opposite the plural pixel electrodes corresponding to one of the second data line sets.

3. The electrophoretic display panel according to claim 1, wherein the plural common electrodes are disposed opposite the plural pixel electrodes corresponding to one of the second data line sets so as to be parallel to an arrangement direction of the data lines of the second data line set.

4. The electrophoretic display panel according to claim 1,
wherein the plural scanning lines includes a first scanning line set including plural signal lines and second scanning line sets each including plural signal lines branched from each of the plural signal lines of the first scanning line set,
wherein the second scanning line sets intersect with the second data line sets, and
wherein each of the plural common electrodes is disposed opposite the plural pixel electrodes corresponding to a location where one of the second data line sets interests with one of the second scanning line sets.

5. The electrophoretic display panel according to claim 1, wherein each of the plural pixel electrodes is supplied with voltage through an organic transistor.

6. A method of driving an electrophoretic display panel which includes an element substrate, a counter substrate, and an electrophoretic display layer interposed between the element substrate and the counter substrate,
wherein the element substrate includes a first data line set including plural data lines, second data line sets each including plural data lines branched from each of the plural data lines of the first data line set, plural scanning lines, and plural pixel electrodes,
wherein the plural pixel electrodes are disposed at locations where the plural data lines of the second data line sets intersect with the plural scanning lines,
wherein the counter substrate includes plural common electrodes and one or more common electrodes is disposed opposite the plural pixel electrodes corresponding to one of the second data line sets,
wherein a data signal output to the first data line set is updated by the number of the second data line sets while one of the plural scanning lines is driven to be in an active state, and
wherein voltage necessary for display change is supplied at update timing of the data signal to one of the plural common electrodes disposed opposite the location corresponding to one of the second data line sets corresponding to the updated data signal.

7. The method according to claim 6, wherein one of the plural common electrodes is disposed opposite the plural pixel electrodes corresponding to one of the second data line sets.

8. The method according to claim 6,
wherein the plural common electrodes are disposed opposite the plural pixel electrodes corresponding to one of the second data line sets so as to be parallel to an arrangement direction of the data lines of the second data line set, and
wherein each of the data lines corresponding to the disposed plural common electrodes is updated in update of the number of the second data line sets, and the voltage necessary for display change is supplied to one of the plural common electrodes at the update timing.

9. The method according to claim 6,
wherein the plural scanning lines includes a first scanning line set including plural signal lines and second scanning line sets each including plural signal lines branched from each of the plural signal lines of the first scanning line set,
wherein the second scanning line sets intersect with the second data line sets,
wherein each of the plural common electrodes is disposed opposite the plural pixel electrodes corresponding to a location where one of the plural second data line sets interests with one of the plural second scanning line sets, and
wherein the voltage necessary for the display change is supplied to one of the plural pixel electrodes by driving one of the plural signal lines at a display location of a data signal output the second data line sets.

10. The method according to claim 9, wherein the voltage necessary for the display change is simultaneously supplied to two of the plural common electrodes adjacent to each other in a direction parallel to the arrangement direction of the second scanning line sets during a certain period.
